(19) United States
(12) Patent Application Publication
(10) Pub. No.: US 2023/0011413 A1
(43) Pub. Date: Jan. 12, 2023

(54) SECURE RESTORE OF A COMPUTING SYSTEM

(71) Applicant: Hewlett Packard Enterprise Development LP, Houston, TX (US)

(72) Inventors: Gavin Brebner, St. Martin D'Uriage (FR); Siva Subramaniam Manickam, Bangalore Karnataka (IN)

(21) Appl. No.: 17/454,936

(22) Filed: Nov. 15, 2021

(30) Foreign Application Priority Data
Jul. 8, 2021 (EP) 21305940.5

(51) Int. Cl. G06F 11/14; G06F 21/78

(52) U.S. Cl. CPC G06F 11/1484; G06F 11/1469; G06F 11/1464; G06F 11/1451; G06F 21/78

(57) ABSTRACT

Examples described herein relate to a method and a system, for example, a restore management system for providing secure restore of computing system. In some examples, the restore management system may determine that the computing system is restored. Further, the restore management system may isolate the computing system by restricting access to the computing system for any data traffic other than data traffic associated with a security fix to be applied to the computing system. Furthermore, the restore management system may determine that the security fix has been successfully applied to the computing system and, in response to determining that the security fix has been successfully applied, the restore management system may remove the computing system from isolation.

### BACKGROUND

Computing systems may host data and/or applications. A computing system may be a server, a storage array, a cluster of servers, a computer appliance, a workstation, a storage system, a converged system, a hyperconverged system, or the like. In some implementations, resources of a computing system may be virtualized and deployed as virtual machines, containers, a pod of containers, or the like, which may act as virtual computing systems.

### BRIEF DESCRIPTION OF THE DRAWINGS

FIG. 1 depicts an example network environment including a restore management system for providing secure restore of a computing system deployed in a workload environment;

FIG. 2 depicts a block diagram of an example restore management system;

FIG. 3 depicts a flow diagram of an example method for providing secure restore of a computing system;

FIG. 4 depicts a flow diagram of another example method for providing secure restore of a computing system; and

FIG. 5 depicts a flow diagram of yet another example method for providing secure restore of a computing system.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements may be coupled mechanically, electrically, or communicatively linked through a communication channel, pathway, network, or system. Further, the term “and/or” as used herein refers to and encompasses any and all possible combinations of the associated listed items. As used herein, the term “includes” means includes but not limited to, the term “including” means including but not limited to.

Data and/or applications may be hosted on bare metal computing systems (also referred to as physical computing systems), such as, a server, a storage array, a cluster of servers, a computer appliance, a workstation, a storage system, a converged system, a hyperconverged system, or the like. In some implementations, resources of the computing systems may be virtualized and deployed as virtual computing systems (also referred to as virtual resources) on the physical computing systems. Examples of virtual computing systems may include, but are not limited to, a virtual machine (VM), a container, a pod of containers, a database, a data store, a logical disk. A VM may include an instance of an operating system hosted on a given computing system via a VM host program such as a hypervisor. A container may be an application packaged with its dependencies (e.g., operating system resources, processing allocations, memory allocations, etc.) hosted on a given computing system via a container host program such as a container runtime (e.g., Docker Engine), for example. One or more containers may be grouped to form a pod. For example, a set of containers that are associated with a common application may be grouped to form a pod. One or more applications may be executed on a virtual computing system, which is in turn executing on physical hardware-based processing resources. In some examples, applications may execute on a bare metal computing system, via an operating system for example. In the description hereinafter, the term “computing system” may be understood to mean a virtual computing system or a bare metal computing system.

A user can deploy and manage a virtual computing system on one or more physical computing systems using management systems, such as, a VM host program, a container runtime, a container orchestration system (e.g., Kubernetes), and the like. For example, in a cloud environment, customers (e.g., authorized users of the cloud environment) may create the virtual computing systems and manage the virtual computing systems in a self-service manner. Further, in some examples, the computing systems (physical or virtual) may be backed up (e.g., archived). In respect of a computing system, the term “backup” as used herein may refer to the content of the computing system, including but not limited to, data and/or state information associated with the computing system at a given point in time. The backup may be a full backup or an incremental backup. The full backup may include all the content of the computing system. The incremental backup may contain incremental (e.g., differential) data and state information associated with the computing system with reference to a previously created backup of the computing system.

By way of example, for a virtual computing system such as a VM, the full backup may include a snapshot, a remote copy, or a cloud copy of the VM. A snapshot corresponding to the VM may refer to a point in time copy of the content associated with the VM. The snapshots may be stored locally within the physical computing system hosting the VM. In some examples, several snapshots may be maintained to record the changes over a period. Further, the remote copy may refer to a copy or duplicate of the data associated with the VM. In the context of the VM referenced hereinabove, a remote copy of the VM may refer to a copy of the data associated with the VM at a given point in time and stored on a physical computing system separate from a physical computing system hosting the VM, thereby making it suitable for disaster recovery. Moreover, the cloud copy may refer to a copy of the backup stored remotely on storage offered by a cloud network (public or private), also referred to as a cloud storage system.

A computing system may be restored using the backup of the computing system. Generally, once restored, the computing system may be in a state similar to the state of the computing system at a time when the backup was created, and then one or more security fixes may be applied to the computing system. Also, once restored, certain security fixes may be applied to the computing system to minimize vulnerability to any cybersecurity attacks on the computing system. Typically, the security fixes arrive in a steady stream after the computing system is restored and becomes accessible to applications and/or users. Any computing system that is made accessible to applications and/or users but has not yet had a security fix applied or has missed a security fix and/or software update may be a security vulnerability in a customer's data center.

To address the foregoing problems, examples described herein may equip a restored computing system with security fixes and/or software updates so that the restored computing system is less vulnerable to security attacks when the restored computing system is made accessible. In some examples, the restore management system may determine if the computing system is restored. Further, the restore management system may isolate the computing system by restricting access to the computing system for any data traffic other than data traffic associated with a security fix and/or software update to be applied to the computing system. Furthermore, the restore management system may determine if the security fix has been successfully applied to the computing system. In response to determining that the security fix has been successfully applied, the restore management system may remove the computing system from isolation.

As will be appreciated, in some examples, the restore management system controls access to the computing system that is restored. In particular, after the computing system is restored, the computing system may be made accessible to its authorized users and/or applications, after the computing system is successfully updated to have the security fixes and/or software updates. This is achieved at least partially by isolating the computing system by restricting access to the computing system for any data traffic other than data traffic associated with the security fix and/or software update to be applied to the computing system. In this way, the restore management system may ensure that the computing system is secured (e.g., security of the computing system is up to date) and is less prone to security attacks when made accessible to its authorized users and/or applications.

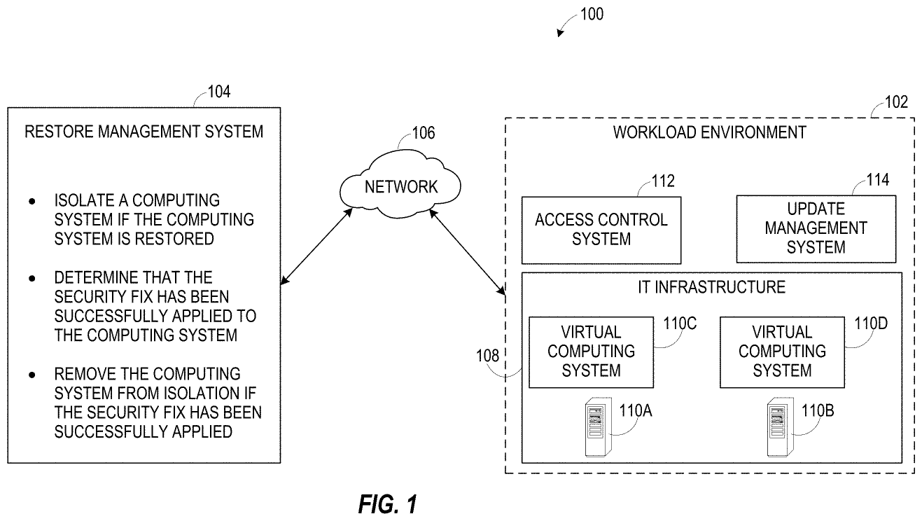

Referring now to the drawings, in FIG. 1, an example network environment 100 is presented. The network environment 100 may include a workload environment 102 and a restore management system 104. In some examples, as depicted in FIG. 1, the restore management system 104 may be located outside of the workload environment 102 and communicate with the workload environment 102 via a network 106, as depicted in FIG. 1. However, the scope of the present disclosure should not be limited to the implementation depicted in FIG. 1. In some examples, the restore management system 104 may be deployed within the workload environment 102. The workload environment 102 may be an on-premise network infrastructure of an entity (e.g., an individual or an organization or enterprise), a private cloud network, a public cloud network, or a hybrid public-private cloud network.

In some examples, the workload environment 102 may include an IT (information technology) infrastructure 108. In one example, the IT infrastructure 108 may be a data center hosted at the workload environment 102. The IT infrastructure 108 may be a network of computing systems such as, for example, computing systems 110A, 110B, 110C, and 110D (hereinafter collectively referred to as computing systems 110A-110D), hosted at the workload environment 102. Also, in some examples, the computing systems 110A-110D may have respective identities, such as, for example, Media Access Control (MAC) addresses and/or Internet Protocol (IP) addresses, at which the computing systems 110A-110D may be reachable. Further, in some examples, the computing systems 110A-110D may be accessed for utilizing its compute, storage, and/or networking capabilities by applications running within the workload environment 102 or outside of the workload environment 102. For example, the application may be executing on any of the computing systems 110A-110D or on any other computing system external to the workload environment 102. It is to be noted that the scope of the present disclosure is not limited with respect to the number or type of computing systems 110A-110D deployed in the IT infrastructure 108. For example, although four computing systems 110A-110D are depicted in FIG. 1, the use of greater or fewer computing systems is envisioned within the purview of the present disclosure.

The computing systems 110A-110D may include virtual computing systems and/or bare metal computing systems. For illustration purposes, in the example implementation of FIG. 1, the computing systems 110A, 110B are described as being bare metal computing systems, and the computing systems 110C, 110D are described as being virtual computing systems. Examples of the bare metal computing systems may include, but are not limited to, bare metal servers, storage devices, desktop computers, portable computers, converged or hyperconverged systems, or the like. The servers may be blade servers, for example. The storage devices may be storage blades, storage disks, or storage enclosures, for example. The computing systems 110A, 110B may allow operating systems, applications, and/or application management platforms (e.g., workload hosting platforms such as a hypervisor, a container runtime, a container orchestration system, and the like) to run thereon. Virtual computing systems such as, for example, the virtual computing systems 110C, 110D may be hosted on a bare metal computing system such as any of the computing systems 110A, 110B, or any other bare metal computing system. Examples of the virtual computing systems 110C-110D may include, but are not limited to, VMs, containers, pods, or the like. In the description hereinafter, for illustration purposes, the virtual computing systems 110C-110D are described as being VMs.

Access to the computing systems 110A-110D may be controlled via an access control system 112. Also, the computing systems 110A-110D may communicate with any system, device, and/or applications inside or outside of the workload environment 102 via the access control system 112. Any data traffic directed to the computing systems 110A-110D may flow to the IT infrastructure 108 via the access control system 112. In some examples, each of the computing systems 110A-110D may be physically (e.g., via wires) or wirelessly connected to the access control system 112. Also, in some examples, the computing systems 110A-110D may be logically mapped to the access control system 112 so that the computing systems 110A-110D can send and/or receive data traffic via the access control system 112. Further, the access control system 112, may be in communication with the network 106, directly or via intermediate communication devices (e.g., a router or an access point).

The access control system 112 may be a network communication device acting as a point of access to the IT infrastructure 108 and the computing systems 110A-110D hosted on the IT infrastructure 108. Examples of network communication devices that may serve as the access control system 112 may include, but are not limited to, a network switch, a router, a computer (e.g., a personal computer, a portable computer, etc.), a network protocol conversion device, a firewall device, or a server (e.g., a proxy server). In some examples, the access control system 112 may be implemented as software or virtual resource deployed on a physical computing system or distributed across a plurality of computing systems.

Further, in some examples, the workload environment 102 may include an update management system 114 for facilitating software updates (e.g., operating system updates) and/or security fixes, such as, security updates and/or security patches, to the computing systems 110A-110D, thereby reducing vulnerability to security attacks when the computing systems 110A-110D are made accessible. The update management system 114 may store the software updates and/or the security fixes that can be applied to the computing systems 110A-110D. The update management system 114 may be deployed in the workload environment 102 (as depicted) or, in other implementations, may be external to the workload environment 102. In some examples, the update management system 114 may be implemented as a data store, database, and/or a repository, on a computing system similar to any one of the computing systems 110A-110D or on a storage device separate from the computing systems 110A-110D. In some examples, the update management system 114 may be implemented as a virtual computing system similar to the computing systems 110C, 110D, or a software application/service. In some examples, the update management system 114 may be distributed over a plurality of computing systems or storage devices. In some examples, the update management system 114 may be stored in a public cloud infrastructure, a private cloud infrastructure, and/or a hybrid cloud infrastructure.

Communication between the restore management system 104 and the workload environment 102 may be facilitated via the network 106. Examples of the network 106 may include, but are not limited to, an Internet Protocol (IP) or non-IP-based local area network (LAN), wireless LAN (WLAN), metropolitan area network (MAN), wide area network (WAN), a storage area network (SAN), a personal area network (PAN), a cellular communication network, a Public Switched Telephone Network (PSTN), and the Internet. In some examples, the network 106 may be enabled via private communication links including, but not limited to, communication links established via Bluetooth, cellular communication, optical communication, radio frequency communication, wired (e.g., copper), and the like. In some examples, the private communication links may be direct communication links between the restore management system 104 and the workload environment 102.

One or more of the computing systems 110A-110D may be backed up (e.g., archived) via one or more backup techniques by saving a copy of data and/or state information associated with the computing systems 110A-110D. The backup may be a full backup or an incremental backup. The backups may be useful for restoring the computing systems 110A-110D based on respective backups. Once restored, the computing system may be in a state similar to a state at a time when the backup was created, and then one or more security fixes and/or software updates may be applied to the computing system. In the description hereinafter, a secure restore operation will be described with respect to the computing system 110C for illustration purposes. It is to be noted that the other computing systems 110A, 110B, or 110D may also be securely restored in a similar fashion based on respective backups.

In some examples, once powered-on after being restored using its backup, the computing system 110C may initiate a security self-update operation and access the update management system 114 to download an applicable software update and/or security fix, such as, a security update or a security patch, if the computing system 110C is not updated with the latest security fix. The computing system 110C may receive the security fix from the update management system 114 via the access control system 112. In accordance with the aspects of the present disclosure, the restore management system 104 may equip a computing system that is restored with security fixes to reduce the computing system's vulnerability to security attacks when made accessible. In particular, the restore management system 104 may do so by controlling access to the computing system 110C after the computing system 110C is restored.

The restore management system 104 may determine if the computing system 110C is restored. For example, a start of the restore process for the computing system 110C may be triggered by an end user or via an automatic process. Accordingly, the restore management system 104 may determine that the computing system 110C (e.g., VM) is being restored. The restore management system 104 may monitor the progress of the restoration in various ways. For example, if the computing system 110C is being restored from a backup), a prompt to log in to the computing system 110C may indicate that the computing system 110C is restored. Accordingly, the restore management system 104 may determine that the computing system 110C is restored if a login prompt is detected. In other examples, a VM being started using a backup may have an associated status that can be monitored, and a status indicating that the VM is running may indicate that the computing system 110 C is restored. In other examples where an application is running in a container or pod, the application endpoint may be monitored (e.g., by polling) by the restore management system 104, using an application programming interface (API) (e.g., http GET). On a successful API operation (e.g., 200 status from http GET), the restore management system 104 may determine that container, and thus computing system 110C, has been restored.

Further, in some examples, if it is determined that the computing system 110C is restored, the restore management system 104 may isolate the computing system 110C by restricting access to the computing system 110C for any data traffic other than data traffic associated with the security fix and/or software update to be applied to the computing system 110C. In some examples, to enable isolation of the computing system 110C, the restore management system 104 may instruct the access control system 112 to enforce isolation rules by communicating an isolation commencement command to the access control system 112. The isolation commencement command may include an identity (e.g., an IP address and/or a MAC address) of the computing system 110C that is restored.

Accordingly, for any incoming data traffic directed to the computing system 110C (e.g., data traffic including a destination IP address that is an IP address of the computing system 110C), the access control system 112 may verify that the incoming data traffic is associated with the security fix and/or the software update to be applied to the computing system 110C. In one example, the incoming data traffic at the access control system 112 is said to be associated with the security fix if the data traffic includes a predefined identifier or metadata indicative of the security fix. In one example, the incoming data traffic at the access control system 112 is said to be associated with the software update if the data traffic includes another predefined identifier or metadata indicative of the software update. In another example, the incoming data traffic at the access control system 112 is said to be associated with the security fix and/or the software update, if the data traffic is received from the update management system 114 (e.g., include a source IP address that is an IP address associated with the update management system 114).

The restore management system 104 may determine if the security fix has been successfully applied to the computing system 110C. In some examples, certain security fixes may be presumed to take a predetermined duration of time to complete installation, also referred to as, a predetermined security configuration period. Accordingly, the restore management system 104 may determine that the security fix has been successfully applied by determining that the predetermined security configuration period has elapsed after the computing system 110C is powered-on upon restore. In other examples, the computing system 110C may trigger a predetermined event, also referred to as, a security fix completion event. The security fix completion event may be triggered based on successful completion of a process, such as but not limited to, a process “apt-get update && apt-get upgrade —y.” Information related to the process “apt-get update && apt-get upgrade —y” may be found in one or more logs. If it is determined from the logs that the process “apt-get update && apt-get upgrade —y” is completed, the security fix completion event may be triggered. Accordingly, in some examples, the restore management system 104 may determine that the security fix has been successfully applied by determining that the security fix completion event is triggered by the computing system 110C.

In response to determining that the security fix has been successfully applied, the restore management system 104 may remove the computing system 110C from isolation. The restore management system 104 may communicate an isolation termination command to the access control system 112 to remove the computing system 110C from isolation. The isolation termination command may include the identity of the computing system, for example, the computing system 110C to which the security fix is successfully applied so that the access control system 112 can recognize that the computing system 110C is to be removed from isolation. Upon receipt of the isolation termination command, the access control system 112 may discontinue enforcement of the isolation rules on the data traffic directed to the computing system 110C. Once, the enforcement of the isolation rules is discontinued, the computing system 110C may be accessible by authorized customers and/or applications.

In some examples, the restore management system 104 may manage isolation of the restored computing systems with help from the update management system 114. In such implementation, in a process also referred to as a managed security fix operation, in response to determining that the computing system (e.g., the computing system 110C) is restored, the restore management system 104 may instruct the update management system 114 to initiate, based on a restore policy, application of the security fix, such as, a security patch or a security update; or a software update to the computing system 110C. In particular, in some examples, for a given computing system of the computing systems 110A-110D, the restore policy may define which type of updates (e.g., a security patch, a security update; or a software update) are to be applied when the given computing system is restored. In some other examples, the update management system 114 may itself determine that the computing system 110C is restored. In response to receiving instruction from the restore management system 104 or upon determining that the computing system 110C is restored, the update management system 114 may communicate the security fixes to the computing system 110C via the access control system 112.

Further, in some examples of the managed security fix operation, the update management system 114 may communicate an isolation commencement command to the access control system 112. The isolation commencement command sent from the update management system 114 may also include the identity of the computing system that is restored, for example, the computing system 110C. In response to receiving the isolation commencement command from the update management system 114, the access control system 112 may enforce, in a similar fashion as described earlier, the isolation rules for the computing system 110C to ensure that computing system 110C receives no data traffic other than the security fixes.

Furthermore, in some examples of the managed security fix operation, upon successful completion of the security fix or the software update, the update management system 114 may generate a security fix completion alert. The restore management system 104 may receive the security fix completion alert from the update management system 114. The restore management system 104 may determine that the security fix has been successfully applied if the security fix completion alert is received by the restore management system 104. Accordingly, the restore management system 104 may remove the computing system 110C from isolation by communicating the isolation termination command to the network access control system 112 in response to determining that the security fix has been successfully applied. In some other examples, the restore management system 104 may remove the computing system 110C from isolation if both the security fix and the software update are successfully applied.

In some examples, before the computing system 110C is removed from isolation, the restore management system 104 may attempt a dummy security attack the computing system 110C with known exploits and determine whether the computing system 110C is secure. Accordingly, if the computing system 110C is determined to have successfully overcome the dummy security attack, the computing system 110C may remove the computing system 110C from isolation.

As will be appreciated, in some examples, the restore management system 104 controls access to the computing system that is restored. In particular, after the computing system is restored, the computing system may be made accessible to its authorized users and/or applications, after the computing system is successfully updated to have the security fixes and/or software updates. This is achieved at least partially by isolating the computing system by restricting access to the computing system for any data traffic other than data traffic associated with the security fix to be applied to the computing system. In this way, the restore management system 104 may ensure that the computing system is secured and is less prone to security attacks when made accessible to its authorized users and/or applications.

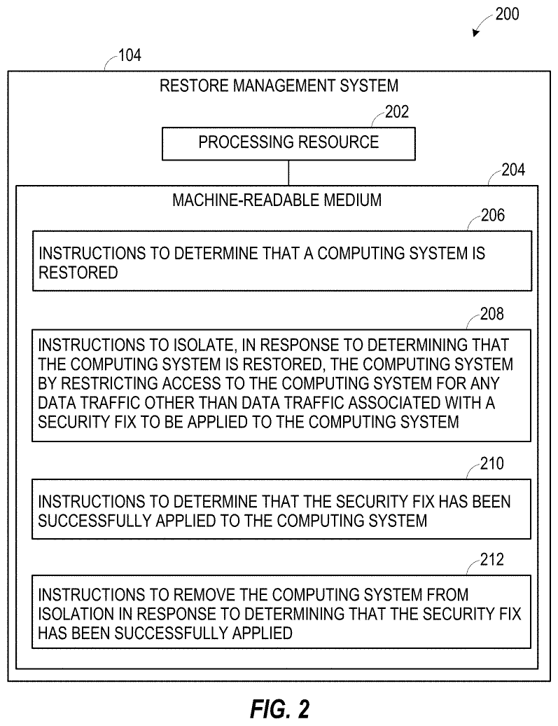

Referring now to FIG. 2, a block diagram 200 of an example restore management system, for example, the restore management system 104, is presented. In some examples, the restore management system 104 may be a processor-based system that performs various operations to restore a computing system, for example, one or more of the computing systems 110A-110D. In some examples, the restore management system 104 may be a device including a processor or a microcontroller and/or any other electronic component, or a device or system that may facilitate compute, data storage, and/or data processing, for example. In other examples, the restore management system 104 may be deployed as a virtual computing system, for example, a VM, a container, a containerized application, or a pod on a physical computing system within the workload environment 102 or outside of the workload environment 102.

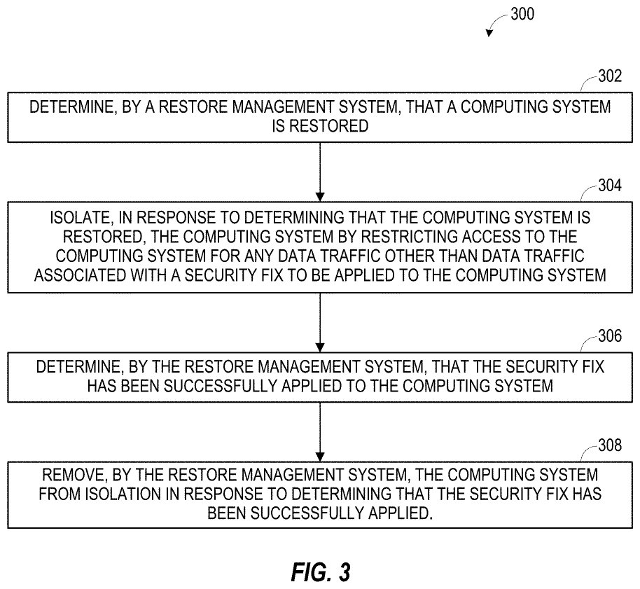

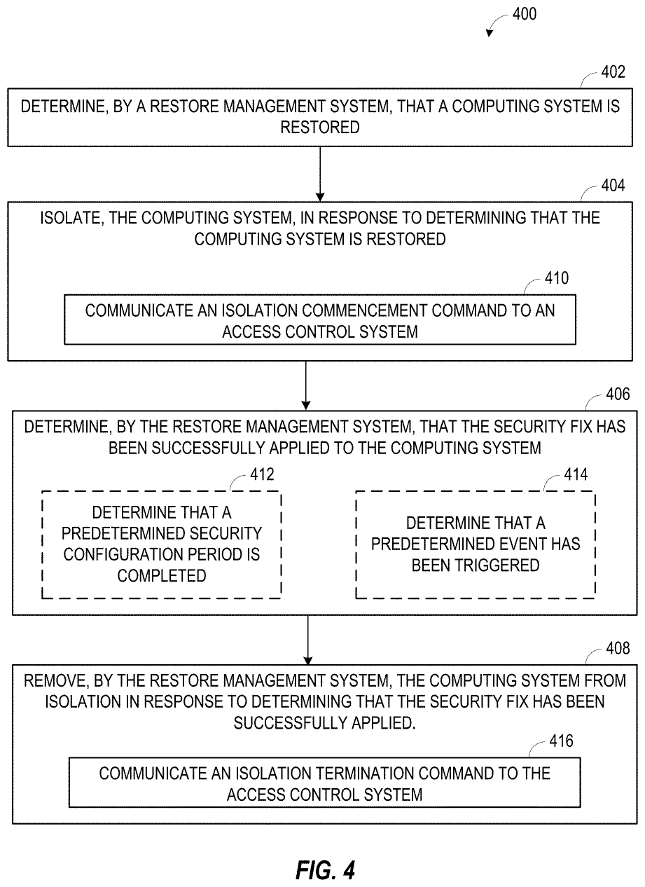

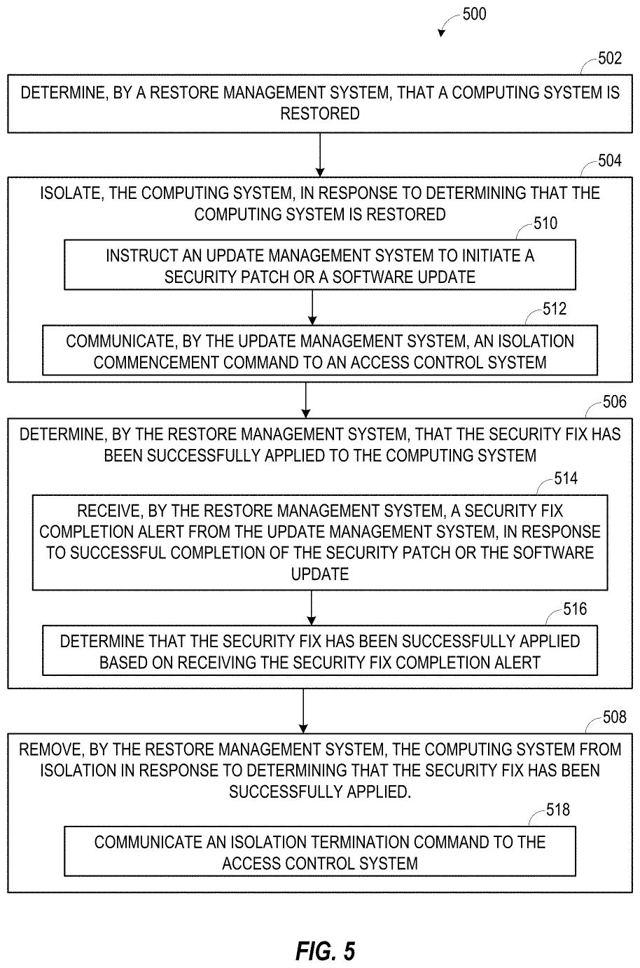

In some examples, the restore management system 104 may include a processing resource 202 and a machine-readable medium 204. The machine-readable medium 204 may be any electronic, magnetic, optical, or other physical storage device that may store data and/or executable instructions 206, 208, 210, and 212 (collectively referred to as instructions 206-212). For example, the machine-readable medium 204 may include one or more of random-access memory (RAM), an Electrically Erasable Programmable Read-Only Memory (EEPROM), a storage drive, a flash memory, a Compact Disc Read-Only Memory (CD-ROM), or the like. The machine-readable medium 204 may be a non-transitory storage medium. As described in detail herein, the machine-readable medium 204 may be encoded with the executable instructions 206-212 to perform one or more blocks of the method described in FIG. 3. The machine-readable medium may also be encoded with additional or different instructions to perform one or more blocks of the methods described in FIGS. 4-5.

Further, the processing resource 202 may be or may include a physical device such as, for example, a central processing unit (CPU), a semiconductor-based microprocessor, a microcontroller, a graphics processing unit (GPU), an application-specific integrated circuit (ASIC), a field-programmable gate array (FPGA), other hardware devices, or combinations thereof, capable of retrieving and executing the instructions 206-212 stored in the machine-readable medium 204. The processing resource 202 may fetch, decode, and execute the instructions 206-212 stored in the machine-readable medium 204 for securely restoring the computing systems 110A-110D. As an alternative or in addition to executing the instructions 206-212, the processing resource 202 may include at least one integrated circuit (IC), control logic, electronic circuits, or combinations thereof that include a number of electronic components for performing the functionalities intended to be performed by the restore management system 104. Moreover, in some examples, where the restore management system 104 may be implemented as a virtual computing system, the processing resource 202 and the machine-readable medium 204 may represent a processing resource and a machine-readable medium of hardware or a computing system that hosts the restore management system 104 as a virtual computing system.

In some examples, the instructions 206 when executed by the processing resource 202 may cause the processing resource 202 to determine if a computing system (e.g., the computing system 110C) is restored. Further, the instructions 208 when executed by the processing resource 202 may cause the processing resource 202 to isolate the computing system, in response to determining that the computing system is restored, by restricting access to the computing system for any data traffic other than data traffic associated with a security fix and/or software update to be applied to the computing system. Furthermore, the instructions 210 when executed by the processing resource 202 may cause the processing resource 202 to determine if the security fix and/or the software update have been successfully applied to the computing system. Moreover, the instructions 212, when executed by the processing resource 202 may cause the processing resource 202 to remove the computing system from isolation in response to determining that the security fix and/or the software update have been successfully applied. Details of the operations carried out by the restore management system 104 to securely restore the computing system are described in conjunction with the methods described in FIGS. 3-5.

In the description hereinafter, several operations performed by the restore management system 104 will be described with reference to flow diagrams depicted in FIGS. 3-5. For illustration purposes, the flow diagrams, depicted in FIGS. 3-5, are described in conjunction with the network environment 100 of FIG. 1 and the block diagram 200 of FIG. 2, however, the methods of FIGS. 3-5 should not be construed to be limited to the example configuration of the network environment 100 and the block diagram 200. The methods described in FIGS. 3-5 may include a plurality of blocks, operations at which may be performed by a processor-based system such as, for example, the restore management system 104. In particular, operations at each of the plurality of blocks may be performed by a processing resource such as the processing resource 202 by executing one or more of the instructions 206-212 stored in the machine-readable medium 204. In particular, the methods described in FIGS. 3-5 may represent an example logical flow of some of the several operations performed by the restore management system 104. However, in some other examples, the order of execution of the blocks depicted in FIGS. 3-5 may be different than the order shown. For example, the operations at various blocks may be performed in series, in parallel, or in a series-parallel combination.

Referring now to FIG. 3, a flow diagram of an example method 300 for performing a secure restore of a computing system, for example, the computing system 110C, is presented. The method 300 may include blocks 302, 304, 306, and 308 (hereinafter collectively referred to as blocks 302-308) that are performed by the restore management system 104. Certain details of the operations performed at one or more of blocks 302-308 have already been described in conjunction with FIG. 1, which is not repeated herein.

At block 302, the method 300 may include determining that a computing system, for example, the computing system 110C, is restored. In some examples, at block 302, the restore management system 104 may perform a check to determine whether the computing system 110C is restored. In some examples, if it is determined that the computing system 110C is not restored, the restore management system 104 may continue to perform the check at block 302. However, if it is determined that the computing system 110C is restored, operation at block 304 may be performed. At block 304, the method 300 may include isolating the computing system 110C by restricting access to the computing system 110C for any data traffic other than data traffic associated with a security fix to be applied to the computing system 110C. Further, in some examples, at block 306, the method 300 may include determining, by the restore management system 104, that the security fix has been successfully applied to the computing system 110C. Moreover, at block 308, the method 300 may include removing, by the restore management system 104, the computing system 110C from isolation in response to determining that the security fix has been successfully applied.

Referring now to FIG. 4, a flow diagram of another example method 400 for performing a secure restore of a computing system, such as the computing system 110C, is presented. The method 400 of FIG. 4 may be representative of one example of the method 300 of FIG. 3 and include certain blocks that are similar to those described in FIG. 3 and certain blocks that describe sub-operations within a given block.

At block 402, the restore management system 104 may determine that the computing system 110C is restored. Further, at block 404, the restore management system 104 may isolate, in response to determining that the computing system 110C is restored, the computing system 110C by restricting access to the computing system 110C for any data traffic other than data traffic associated with a security fix to be applied to the computing system 110C. In some examples, at block 410, the restore management system 104 may communicate an isolation commencement command to an access control system, such as the access control system 112 in communication with the computing system 110C. In particular, in some examples, the isolation commencement command may include an identity (e.g., the IP address or the MAC address) of the computing system 110C that is restored so that the access control system 112 can recognize which computing system is to be isolated. As previously noted, upon receipt of the isolation commencement command, the access control system 112 may enforce the isolation rules so that access to the computing system 110C for any data traffic other than data traffic associated with a security fix is restricted.

Further, at block 406, the restore management system 104 may determine that the security fix has been successfully applied. In some examples, to determine that the security fix has been successfully applied or installed, the restore management system 104, at block 412, may determine that a predetermined security configuration period has elapsed. Alternatively or additionally, in some examples, to determine that the security fix has been successfully applied or installed, the restore management system 104, at block 414, may determine that a predetermined event has been triggered. If any or both of the predetermined security configuration period is elapsed or the predetermined event has been triggered, the restore management system 104 may determine that the security fix has been successfully applied. Although not depicted in FIG. 4, in some examples, the restore management system 104 may determine that a software update has also been successfully applied.

Moreover, at block 408, the restore management system 104 may remove the computing system 110C from isolation in response to determining that the security fix and/or the software update have been successfully applied. In some examples, in order to remove the computing system 110C from isolation, at block 416, the restore management system 104 may communicate an isolation termination command to the access control system 112. The access control system 112, upon receipt of the isolation termination command, may terminate the enforcement of the isolation rules for the computing system 110C, and the computing system 110C may be made accessible to its authorized users.

Turning now to FIG. 5, a flow diagram of yet another example method 500 for performing a secure restore of a computing system, such as the computing system 110C, is presented. The method 500 of FIG. 4 may be representative of one example of the method 300 of FIG. 3 and include certain blocks that are similar to those described in FIG. 3 and certain blocks that describe sub-operations within a given block. At block 502, the restore management system 104 may determine that the computing system 110C is restored.

Further, at block 504, the restore management system 104 may isolate the computing system 110C, in response to determining that the computing system 110C is restored, by restricting access to the computing system 110C for any data traffic other than data traffic associated with a security fix to be applied to the computing system 110C. In some examples, isolating the computing system 110C at block 504 may include performing block 510, where the restore management system 104 may instruct the update management system 114 to initiate a security fix or a software update to the computing system 110C in response to determining that the computing system 110C is restored. Block 504 may further include performing block 512, where the update management system 114 may communicate an isolation commencement command to an access control system 112. As previously noted, the isolation commencement command may include the identity of the computing system that is restored so that the access control system 112 can recognize which computing system is to be isolated. Upon receipt of the isolation commencement command, the access control system 112 may enforce the isolation rules so that access to the computing system 110C for any data traffic other than data traffic associated with a security fix is restricted.

Further, at block 506, the restore management system 104 may determine that the security fix has been successfully applied. In the example method 500, the restore management system 104 may determine that the security fix has been successfully applied based on information received from the update management system 114. For example, block 506 may include performing block 514, where the restore management system 104 may receive a security fix completion alert from the update management system 114 in response to the successful completion of the security fix or the software update. Accordingly, at block 516 of block 506, in response to receiving the security fix completion alert (at block 514), the restore management system 104 may determine that the security fix has been successfully applied or installed on the computing system 110C. Although not depicted in FIG. 5, in some examples, the restore management system 104 may determine that a software update has also been successfully applied or installed on the computing system 110C.

Moreover, at block 508, the restore management system 104 may remove the computing system 110C from isolation in response to determining that the security fix and/or the software update have been successfully applied. In some examples, in order to remove the computing system 110C from isolation, block 508 may include performing block 518, where the restore management system 104 may communicate an isolation termination command to the access control system 112. The access control system 112, upon receipt of the isolation termination command, may terminate the enforcement of the isolation rules for the computing system 110C, and the computing system 110C may be made accessible to its authorized users.

While certain implementations have been shown and described above, various changes in form and details may be made. For example, some features and/or functions that have been described in relation to one implementation and/or process may be related to other implementations. In other words, processes, features, components, and/or properties described in relation to one implementation may be useful in other implementations. Furthermore, it should be appreciated that the systems and methods described herein may include various combinations and/or sub-combinations of the components and/or features of the different implementations described. Moreover, method blocks described in various methods may be performed in series, parallel, or a combination thereof. Further, the method blocks may as well be performed in a different order than depicted in flow diagrams.

Further, in the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

1. A method for enabling a secure restore of a computing system, comprising:
determining, by a restore management system, that the computing system is restored;
in response to determining that the computing system is restored, isolating the computing system by restricting access to the computing system for any data traffic other than data traffic associated with a security fix to be applied to the computing system;
determining, by the restore management system, that the security fix has been successfully applied to the computing system; and
removing, by the restore management system, the computing system from isolation in response to determining that the security fix has been successfully applied.

2. The method of claim 1, wherein the computing system comprises a virtual computing system or bare metal computing system, wherein the virtual computing system comprises a virtual machine (VM), a container, or a pod.

3. The method of claim 1, wherein the computing system is restored by a full backup or an incremental backup.

4. The method of claim 3, wherein the computing system is a VM, and wherein the full backup comprises a snapshot of the VM, a remote copy of the VM, or a cloud copy of the VM.

5. The method of claim 1, wherein isolating the computing system comprises communicating, by the restore management system, an isolation commencement command to an access control system in communication with the computing system, wherein the isolation commencement command comprises an identity of the computing system that is restored.

6. The method of claim 1, wherein determining that the security fix has been successfully applied comprises:
determining, by the restore management system, that a predetermined security configuration period is elapsed; or
determining, by the restore management system, that a predetermined event has been triggered.

7. The method of claim 1, wherein isolating the computing system comprises instructing, by the restore management system and based on a restore policy, an update management system to initiate the security fix or a software update to the computing system in response to determining that the computing system is restored.

8. The method of claim 7, wherein isolating the computing system comprises communicating, by the update management system, an isolation commencement command to an access control system in communication with the computing system, wherein the isolation commencement command comprises an identity of the computing system that is restored.

9. The method of claim 8, wherein determining that the security fix has been successfully applied comprises:
receiving, by the restore management system, a security fix completion alert from the update management system, in response to successful completion of the security fix or the software update; and
determining that the security fix has been successfully applied based on receiving the security fix completion alert.

10. A restore management system, comprising:
a machine-readable medium storing instructions; and
a processing resource communicatively coupled to the machine-readable medium, wherein one or more of the instructions when executed by the processing resource cause the processing resource to:
determine that a computing system is restored;
in response to determining that the computing system is restored, isolate the computing system by restricting access to the computing system for any data traffic other than data traffic associated with a security fix to be applied to the computing system;
determine that the security fix has been successfully applied to the computing system; and
remove the computing system from isolation in response to determining that the security fix has been successfully applied.

11. The restore management system of claim 10, wherein the computing system is restored by a full backup or an incremental backup.

12. The restore management system of claim 10, wherein, to isolate the computing system, the processing resource is to execute one or more of the instructions to communicate an isolation commencement command to an access control system in communication with the computing system, wherein the isolation commencement command comprises an identity of the computing system that is restored.

13. The restore management system of claim 10, wherein, to determine that the security fix has been successfully applied, the processing resource is to execute one or more of the instructions to:
determine that a predetermined security configuration period is elapsed; or
determine that a predetermined event has been triggered.

14. The restore management system of claim 10, wherein the processing resource is to execute one or more of the instructions to instruct, based on a restore policy, an update management system to initiate the security fix or a software update to the computing system in response to determining that the computing system is restored.

15. The restore management system of claim 14, wherein the processing resource is to execute one or more of the instructions to:
receive a security fix completion alert from the update management system, in response to successful completion of the security fix or the software update; and
determine that the security fix has been successfully applied based on receiving the security fix completion alert.

16. A non-transitory machine-readable medium storing instructions executable by a processing resource, the instructions comprising:
instructions to determine that a computing system is restored;
instructions to isolate, in response to determining that the computing system is restored, the computing system by restricting access to the computing system for any data traffic other than data traffic associated with a security fix to be applied to the computing system;
instructions to determine that the security fix has been successfully applied to the computing system; and
instructions to remove the computing system from isolation in response to determining that the security fix has been successfully applied.

17. The non-transitory machine-readable medium of claim 16, wherein the instructions to isolate the computing system comprises instructions to communicate an isolation commencement command to an access control system in communication with the computing system, wherein the isolation commencement command comprises an identity of the computing system that is restored.

18. The non-transitory machine-readable medium of claim 16, wherein the instructions to determine that the security fix has been successfully applied comprises:
instructions to determine that a predetermined security configuration period is elapsed; or
instructions to determine that a predetermined event has been triggered.

19. The non-transitory machine-readable medium of claim 16, wherein the instructions to isolate the computing system comprises instructions to instruct an update management system to initiate the security fix or a software update to the computing system in response to determining that the computing system is restored.

20. The non-transitory machine-readable medium of claim 19, wherein the instructions to determine that the security fix has been successfully applied comprises:
instructions to receive a security fix completion alert from the update management system, in response to successful completion of the security fix or the software update; and
instructions to determine that the security fix has been successfully applied based on receiving the security fix completion alert.
